(19) United States
(12) Patent Application Publication
(10) Pub. No.: US 2026/0161892 A1
(43) Pub. Date: Jun. 11, 2026

(54) METHOD, APPARATUS, DEVICE AND MEDIUM FOR MANAGING TEXT RESOURCE IN APPLICATION

(71) Applicant: Beijing Zitiao Network Technology Co., Ltd., Beijing (CN)

(72) Inventor: Yongkang DONG, Beijing (CN)

(21) Appl. No.: 19/348,719

(22) Filed: Oct. 2, 2025

(30) Foreign Application Priority Data
Dec. 5, 2024 (WO) PCT/CN2024/137076

(51) Int. Cl. G06F 40/279; G06F 40/263

(52) U.S. Cl. CPC G06F 40/279; G06F 40/263

(57) ABSTRACT

A method, apparatus, device and media for managing text resources in an application are provided. In one method, a text resource mapping of the application is obtained, the text resource mapping including a text of a control in the application and a keyword of the text of the control. In response to receiving an interaction request with the application, a target control in the application is determined based on the interaction request. A target text corresponding to the target control is determined. In response to determining that the target text matches the text, the keyword of the text are determined based on the text resource mapping. With some implementations of the present disclosure, the text resource mapping may store a bidirectional mapping relationship between the text and the keyword of the text.

### CROSS-REFERENCE

The present application claims priority to International Patent Application No. PCT/CN2024/137076, Dec. 5, 2024 and entitled “METHOD, APPARATUS, DEVICE AND MEDIUM FOR MANAGING TEXT RESOURCE IN APPLICATION”, the entirety of which is incorporated herein by reference.

### FIELD

Implementations of the present disclosure generally relate to application management, and in particular, to methods, apparatuses, devices, and computer-readable storage media for managing text resources in applications.

### BACKGROUND

With the development of computer technologies and network technologies, applications may provide a variety of functions. An interface of an application may comprise a large number of controls to perform a variety of functions, respectively. A text may be presented at a control in order to indicate a functionality of the control. During the development of the application, a developer may often adjust text presented at the control, which results in a need to maintain a correspondence between a large number of controls and a large number of texts. In particular, in a multi-language environment, there is a need to present translations of multiple languages of the text, which results in a further increase in the number of texts. At this time, it is desirable to manage a large number of text resources in the application in a more convenient and efficient manner.

### SUMMARY

In a first aspect of the present disclosure, there is provided a method for managing text resources in an application. In the method, a text resource mapping of an application is obtained, the text resource mapping comprises a text of a control in the application and a keyword of the text of the control. In response to receiving an interaction request with the application, a target control in the application is determined based on the interaction request. A target text corresponding to the target control is determined. In response to determining that the target text matches the text, the keyword of the text is determined based on the text resource mapping.

In a second aspect of the present disclosure, there is provided an apparatus for managing text resources in an application. The apparatus comprises: an obtaining module configured to obtain a text resource mapping of the application, the text resource mapping comprises a text of a control in the application and a keyword of the text of the control; a control determining module configured to determine, in response to receiving an interaction request with the application, a target control in the application based on the interaction request; a text determining module configured to determine a target text corresponding to the target control; and a keyword determining module configured to determine, in response to determining that the target text matches the text, the keyword of the text based on the text resource mapping.

In a third aspect of the present disclosure, there is provided an electronic device. The electronic device comprises: at least one processor; and at least one memory coupled to the at least one processor and storing instructions for execution by the at least one processor, the instructions, when executed by the at least one processor, causing the electronic device to perform the method according to the first aspect of the present disclosure.

In a fourth aspect of the present disclosure, there is provided a computer-readable storage medium having stored thereon a computer program that, when executed by a processor, causes the processor to implement the method according to the first aspect of the present disclosure.

In a fifth aspect of the present disclosure, there is provided a computer program product comprising a computer program, wherein the computer program, when executed by a processor, implements the method according to the first aspect of the present disclosure.

It should be understood that the content described in this disclosure is not intended to limit key features or important features of implementations of the present disclosure, nor is it intended to limit a scope of the present disclosure. Other features of the present disclosure will become readily understood from following description.

### BRIEF DESCRIPTION OF DRAWINGS

The above and other features, advantages, and aspects of the various implementations of the present disclosure will become more apparent from the following detailed description taken in conjunction with the accompanying drawings. In the drawings, the same or similar reference numbers refer to the same or similar elements, wherein:

FIG. 1 illustrates a block diagram of an application environment according to an implementation of the present disclosure;

FIG. 2 illustrates a block diagram for managing text resources in an application according to some implementations of the present disclosure;

FIG. 3 illustrates a block diagram of configuration information of an application according to some implementations of the present disclosure;

FIG. 4 illustrates a block diagram of a process for determining a text resource mapping according to some implementations of the present disclosure;

FIG. 5 illustrates a block diagram of a process for modifying a text according to some implementations of the present disclosure;

FIG. 6 illustrates a block diagram of configuration information applied in a multi-language environment according to some implementations of the present disclosure;

FIG. 7 illustrates a flowchart of a method for managing text resources in an application according to some implementations of the present disclosure;

FIG. 8 illustrates a block diagram of an apparatus for managing text resources in an application according to some implementations of the present disclosure; and

FIG. 9 illustrates a block diagram of a device capable of implementing various implementations of the present disclosure.

### DETAILED DESCRIPTION

Implementations of the present disclosure will be described in more detail below with reference to drawings. While certain implementations of the present disclosure are shown in the drawings, it should be understood that the present disclosure may be implemented in various forms and should not be construed as limited to the implementations set forth herein, but rather, these implementations are provided for a more thorough and complete understanding of the present disclosure. It should be understood that the drawings and implementations of the present disclosure are for illustrative purposes only and are not intended to limit a scope of the present disclosure.

In the description of implementations of the present disclosure, the terms “comprise” and similar terms should be understood to comprise “comprising but not limited to”. The term “based on” should be understood as “based at least in part on”. The terms “one implementation” or “the implementation” should be understood as “at least one implementation”. The term “some implementations” should be understood as “at least some implementations”. Other explicit and implicit definitions may also be comprised below. As used herein, the term “model” may represent an association relationship between various data. For example, the association relationship may be obtained based on various technical solutions currently known and/or to be developed in future.

It may be understood that data involved in the technical solution (comprising but not limited to the data itself, obtaining or use of the data) should follow requirements of corresponding laws and regulations and related regulations.

It may be understood that, before the technical solutions disclosed in embodiments of the present disclosure are used, a type of personal information related to the present disclosure, a usage scope, a usage scenario and the like should be notified to a user in an appropriate manner according to relevant laws and regulations, and authorization of the user is obtained.

For example, in response to receiving an active request from a user, prompt information is sent to the user to explicitly prompt the user that requested operation will need to obtain and use the personal information of the user. Therefore, the user may autonomously select whether to provide the personal information to software or hardware executing an operation of the technical solution of the present disclosure according to the prompt information.

As an optional but non-limiting implementation, in response to receiving an active request of the user, a manner of sending prompt information to the user may be, for example, a pop-up window, and prompt information may be presented in a text manner in the pop-up window. In addition, the pop-up window may further carry a selection control for the user to select “agree” or “not agree” to provide personal information to the electronic device.

It may be understood that the foregoing notification and obtaining a user authorization process is merely illustrative, and does not constitute a limitation on implementations of the present disclosure, and other manners of meeting related laws and regulations may also be applied to implementations of the present disclosure.

The term “in response to” as used herein means a state in which a respective event occurs or condition is satisfied. It will be appreciated that a timing of execution of a subsequent action performed in response to the event or condition is not necessarily strongly correlated with the time at which the event occurs or the condition holds. For example, in some cases, subsequent actions may be performed immediately when an event occurs or a condition holds; while in other cases, subsequent actions may be performed after a period of time elapses after an event occurs or a condition holds.

### Example Environment

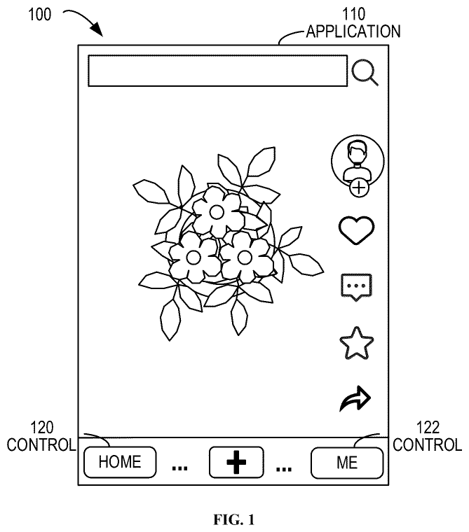

With the development of computer technologies and network technologies, applications may perform a variety of tasks. In the context of the present disclosure, applications may comprise, but are not limited to, video applications, short video applications, social networking applications, music applications, media sharing applications, communication applications, and the like. An interface of the application may provide a number of controls to perform a variety of functions, respectively. Referring to FIG. 1, a block diagram 100 of an application environment according to an implementation of the present disclosure is shown. As shown in FIG. 1, an application 110 may comprise a plurality of controls 120, 122, and so on. A text may be presented at the control in order to represent a functionality of the control. FIG. 1 schematically illustrates an interface of the application 110 in an English environment, for example, the text “HOME” may be presented at the control 120, and the text “ME” may be presented at the control 122. In a Chinese environment, respective Chinese translations of respective texts may be presented at the controls 120 and 122, respectively.

In a development process of an application, the text presented at the control may be continuously adjusted, which leads to a need to maintain a correspondence between a large number of controls and a large number of texts. Further, in a multi-language environment, there is a need to present translations of multiple languages of the text, which results in a further increase in the number of texts. Currently, key-value pairs have been proposed to manage text resources in applications. Specifically, the text (i.e., string) may be stored in a field “value,” and the keyword of the text is stored in a field “key”. However, the key-value pair supports only an one-way search, that is, the corresponding “value” can only be found from the “key”, but the corresponding “key” cannot be reversely found from the “value”.

In the development and testing process, only the text may be presented at the control in the interface of the application. Assuming that a user (e.g., a developer) desires to modify the text “HOME” presented at the control 120, the developer does not know the keyword of the text, thereby the text to be modified can only be manually searched. At this time, it is desirable to manage a large number of text resources in the application in a more convenient and efficient manner.

### Summary of Text Resource Management

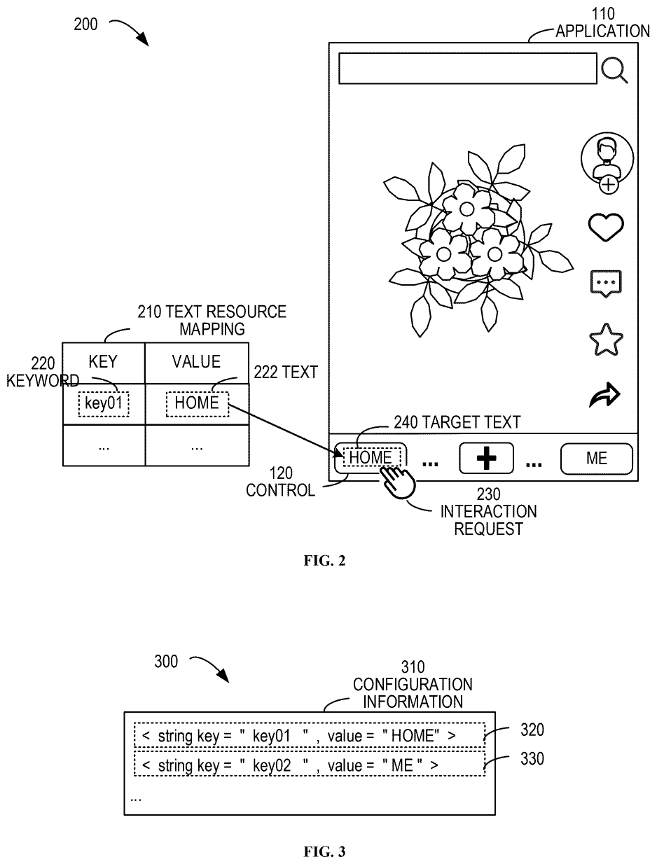

In order to at least partially remove the drawbacks in the prior art, according to an implementation of the present disclosure, a method is provided for managing text resources in an application. FIG. 2 depicts a summary according to some implementations of the present disclosure, which illustrates a block diagram 200 for managing text resources in an application. As shown in FIG. 2, the text resource mapping 210 of the application 110 may be obtained, the text resource mapping 210 comprises a text of a control in the application 110 and a keyword of the text of the control. The text resource mapping 210 may comprise a plurality of data records, one data record corresponds to one control in the application, and the data record may be stored in a key-value pair. For the control 120, the field “value” may store the text 222 (i.e., “HOME”) to be displayed at the control 120, and the field “key” may store a keyword 220 (i.e., “key01”) of the text 222.

The user may interact with the application 110, via interactions for example, a single click, a double click, a long press, a slide, etc. In response to receiving an interaction request 230 with the application 110, a target control in the application 110 may be determined based on the interaction request 230. Because the interaction request 230 corresponds to the control 120, the target control is the control 120. A target text 240 (i.e., “HOME”) corresponding to the target control (i.e., control 120) may be determined. The target text 240 may be searched in the text resource mapping 210. In response to determining that the target text 240 matches the text 222, the keyword 220 of the text 222 may be determined based on the text resource mapping 210, that is, it is determined that the keyword of the target text is “key01”.

With some implementations of the present disclosure, the text resource mapping may store a bidirectional mapping relationship between the text and the keyword of the text. In this way, the text resources in the application may be managed in a simpler and effective manner, helping the user to adjust specific content of the text in the development and testing process.

### Detailed Procedure for Text Resource Management

Having described a summary according to some implementations of the present disclosure, more details regarding a method for managing text resources in an application will be described below. According to some implementations of the present disclosure, a text and a corresponding keyword presented at a control may be specified in configuration information of the application. Further details are described with reference to FIG. 3, which illustrates a block diagram 300 of configuration information of an application according to some implementations of the present disclosure. As shown in FIG. 3, a first row 320 corresponds to a control 120, and a text “HOME” may be presented at the control 120, and a corresponding keyword is “key01”; a second row 330 corresponding to a control 122, and the text “ME” may be presented at the control 122, and a corresponding keyword is “key02”, and so on.

In the context of the present disclosure, configuration information 310 may be stored in different ways. For example, the configuration information 310 may be stored in a configuration file (e.g., an xml format or other customized formats), a data table, or the like, and code of the application may read the configuration information 310. Alternatively and/or additionally, the code of the application may comprise configuration information 310, at which point the application may directly invoke the configuration information 310.

According to some implementations of the present disclosure, the text resource mapping may be determined in a variety of ways, and the text resource mapping may be stored in a memory of a computing device running the application. Specifically, the text and the keyword of the text may be read from the configuration information of the application, and the text resource mapping is determined based on the text and the keyword. For example, the configuration information may be read directly during a compilation process of the application. In another example, a plug-in technology may be used to read the text and the keyword of the text, so that the text resource mapping is determined.

The text resource mapping may be stored in a variety of formats. For example, for a certain control, a string pair <string1, string2> may be used to store the text resource mapping. At this time, string1 may store the keyword and string2 may store the text. Specifically, the text resource mapping corresponding to the control 120 may be represented as: <“key01”, “HOME”>, and the text resource mapping corresponding to the control 122 may be represented as: <“key02”, “ME”>. Alternatively and/or additionally, the text resource mapping may be stored using a data table and/or another format. With some implementations of the present disclosure, the text resource mapping may be determined in a simpler and efficient manner to support bidirectional searching.

According to some implementations of the present disclosure, the text resource mapping may be determined during running of the application. Specifically, a class corresponding to a text resource in the application may be obtained; the keyword of the text and a resource identifier corresponding to the keyword are extracted from the class; and the text resource mapping is determined based on a text of the text resource identified by the resource identifier and the keyword.

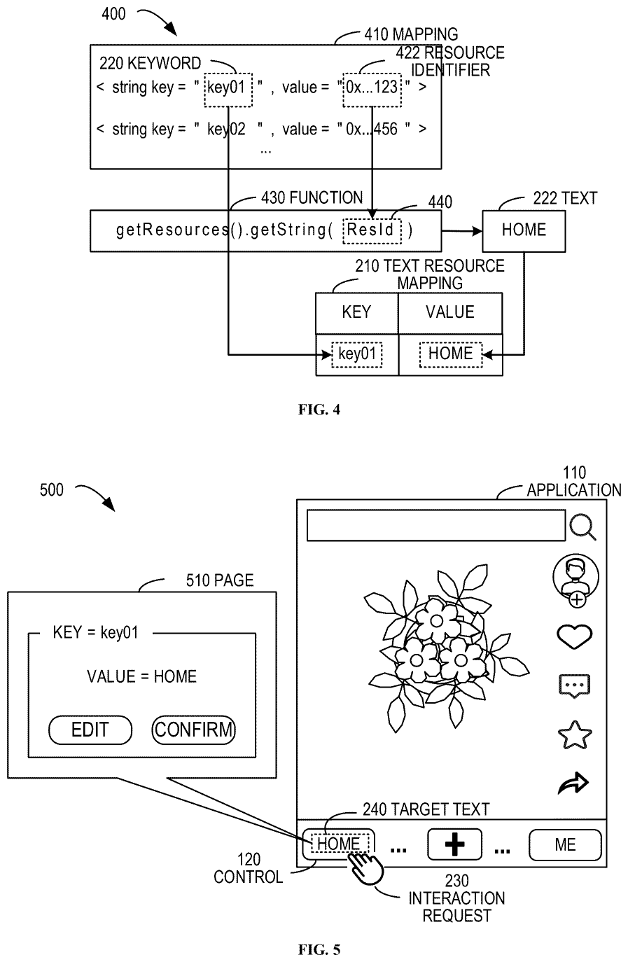

In this example, the application has determined relevant information (for example, the text and the corresponding keyword) of a text resource of each control from the configuration information, and a corresponding class of the text resource has been generated during running of the application, for example, Resource. String.class (or another name). Specifically, the class may comprise keywords and resource identifiers for all text resources. Here, the keyword may be represented in a string, and the resource identifier may be represented, for example, in a hexadecimal number. Further details are described with reference to FIG. 4, which illustrates a block diagram 400 of a process for determining text resource mapping according to some implementations of the present disclosure.

As shown in FIG. 4, a mapping 410 may be established based on keywords and resource identifiers read from the class, which may represent a mapping relationship between the keyword 220 and a resource identifier 422. For example, a first row in the mapping 410 represents a keyword “key01” for a text corresponding to the control 120, and a corresponding resource identifier is “0x . . . 123”. The second row in mapping 410 represents the keyword “key02” for the text corresponding to the control 122, and the corresponding resource identifier is “0x . . . 456.” Further, a function 430 may be utilized to determine a text 222 corresponding to a certain resource identifier (e.g., represented by parameter 440 “ResId”).

For the control 120, ResId=0x . . . 123 and the corresponding text 222 may be determined to be “HOME” by calling the function 430. It should be understood that the function getResources( ).getString herein is merely a specific example of a function for determining the text from a resource identifier. Alternatively and/or additionally, in different programming environments, other functions may be used to determine the respective texts. Further, the keyword 220 and the text 222 may be used to determine the text resource mapping corresponding to the control 120. With some implementations of the present disclosure, relevant text resources of various controls may be dynamically determined during running of the application. At this time, the relevant information of the text resource has been integrated into an executable version of the application, so that additional configuration information does not need to be analyzed, but the executable version may be directly utilized to determine the text resource mapping.

According to some implementations of the present disclosure, in a process of determining a target text corresponding to the target control, a text view corresponding to the target control in the application may be determined, and then the target text is determined in the text view. In the process of running the application, an interaction request between a user and a control may be detected, and the interaction request may have various types, for example, comprising but not limited to a single-click, a double-click, a long press, a slide, and the like. Assuming it is detected that a user clicks the control 120, a clicked view type corresponding to the control 120 may be determined. If a type of the view is a text view, the text presented in the text view may be used as the target text. If the type of the view is a non-text view, other interaction requests of the user may continue to be detected.

The user may run the application and test whether the functionality of the application meets expectations, it may be predefined: in a case that a predetermined type of interaction request is received, a keyword corresponding to the text of the interaction request is determined. For example, the predetermined type may comprise, for example, “a long press” type. In a process of testing an application, for other types of interaction requests other than the predetermined type, the application may process in a conventional manner. For example, when the user clicks on the control 120, the application may present a “HOME” page. In another example, when the user presses the control 120, a text “HOME” presented at the control 120 may be determined, and then the corresponding keyword is searched in the text resource mapping 210 which is determined according to the method described above. Specifically, “HOME” may be searched in the text resource mapping 210 as shown in FIG. 4, so as to determine a corresponding keyword “key01”.

According to some implementations of the present disclosure, in response to receiving an edit request for the text, the text in the text resource mapping may be updated. More details are described with reference to FIG. 5, which illustrates a block diagram 500 of a process for modifying a text according to some implementations of the present disclosure. As shown in FIG. 5, during a process of running the application 110, an interaction request 230 between a user and a control 120 may be detected, a corresponding target text 240 is determined, and a keyword “key01” of the target text 240 is determined according to the method described above. For example, after “a long press” type of interaction request is detected, a page 510 may be presented. The page 510 may comprise a determined keyword “key01”, and a corresponding text “HOME”.

Further, the page 510 may comprise an editing control for editing a text. The user may interact with the editing control, and may modify the text when an interaction request with the editing control is detected. For example, the user may modify “HOME” to “Home” (or another string), at this time, the text in the text resource mapping may be correspondingly modified to “Home”. With some implementations of the present disclosure, text resources in the application may be modified in a simpler and effective manner, thereby improving development and testing efficiency of the application.

It should be understood that in the above examples, although the text resource mapping comprises only a mapping relationship between a keyword and a text, and the text may alternatively and/or additionally relate to a plurality of display attributes, such as a font size, a font, a color, and the like. The text resource mapping may further comprise one or more display attributes. For example, the page 510 may further comprise: font=font1, font size=size1, and color=color1, and so on. In a process of the user adjusting the text, one or more display attributes may be further adjusted. For example, in a process in which the user modifies “HOME” to “Home”, a font, a font size, a color, and the like may be further adjusted. For example, the display attribute may be adjusted to font=font2, font size=size2, and color=color2. In this way, development and testing efficiency may be improved. Alternatively and/or additionally, the configuration information of the application described above may further comprise one or more display attributes. Subsequently, the configuration information of the application may be updated with the modified display attribute.

Alternatively and/or additionally, the technical solutions described above may be implemented in an auxiliary tool different from the application. In particular, the tool may be configured to be displayed on an upper layer of the application in a mode of a floating layer and assist the user in determining keywords corresponding to the text. Specifically, the target text to be processed may be obtained from the application, alternatively and/or additionally, other tools may be used to obtain the target text (for example, obtained from the auxiliary tool, or obtained from the text list to be modified, etc.). The user may click an obtaining control in the tool, and at this time, a plurality of controls for assisting in adjusting an application interface may be presented. For example, a capturing control may be used to select a control in the application, and a positioning control may be used to determine a position of a certain control in the application interface, and a grid control may be used to present a floating grid on the upper layer of application to facilitate determining a position of each control in the application, and a brush control may be used to adjust a control, and so on.

The user may click the obtaining control to select the target control to be adjusted in the application interface. At this time, in response to determining the selected target control, a related text of the target control may be determined, for example, “HOME”. In response to determining that the text belongs to an instance of the text view, a corresponding keyword may be determined, and then content of the text may be adjusted according to the determined keyword. For example, “HOME” may be modified to “Home”, or one or more display attributes may be adjusted.

According to some implementations of the present disclosure, the configuration information of the application may be updated based on the text resource mapping. For example, in a case that the text resource mapping is stored with an xml file, “HOME” in the xml file may be modified to “Home”. In this way, the configuration information of the text resource of the application does not need to be manually modified, but the text may be directly adjusted during development and testing.

According to some implementations of the present disclosure, the method described above may be performed in a development and testing platform of the application. At this time, a developer of the application may run the application directly in the platform and determine whether a text to be presented at each control in the application matches the expectation. In a case that it is desired to adjust the text, a predetermined type of interaction may be performed with the control to be adjusted, to present the keyword of the text. In this way, a reverse process of determining the keyword from the text may be implemented, thereby facilitating updating a specific string of the text.

It should be understood that, although the control 120 in the application 110 is used as an example to describe the process of reversely determining the keyword from the text. The application 110 may comprise multiple pages and each page may comprise a large number of controls, which may be processed in a similar manner. For example, the configuration information may comprise a plurality of rows of data, and a row of data may correspond to one control. In this way, the text resources in the application may be managed in a simpler and effective manner, helping the user to adjust the specific content of the text in the development and testing process.

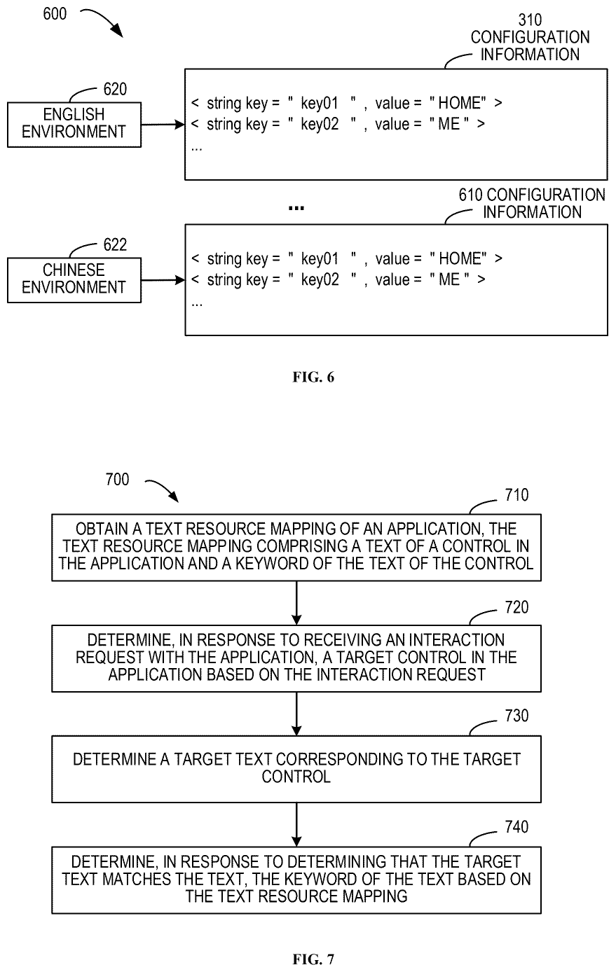

It should be understood that the process of managing text resources is described above only using an English environment as an example of a language environment of the application, alternatively and/or additionally, the application may be implemented in a multi-language environment. According to some implementations of the present disclosure, the application is implemented in a multi-language environment, and the text is represented in a target language of the plurality of languages. Further details are described with reference to FIG. 6, which illustrates a block diagram 600 of configuration information applied in a multi-language environment according to some implementations of the present disclosure. As shown in FIG. 6, the multi-language environment may comprise an English environment 620, a Chinese environment 622, and so on.

Configuration information in each language environment may be provided separately, specifically, under an application environment 620, the configuration information 310 may be provided, and at this time, the application will present a page in English, for example, comprising a control “HOME”, “ME”, and the like. In the application environment 622, the configuration information 610 may be provided, at which point the application will present a page in Chinese, e.g., comprising controls “HOME”, “ME”, etc.

With some implementations of the present disclosure, application development and testing may be handled in a unified manner in a multi-language environment. In each language environment in the multi-language environment, there may be a one-to-many relationship between the keyword and the text. At this time, regardless of the language environment, a corresponding keyword may be provided in a case that the text to be modified is selected, thereby supporting subsequent modification of the content of the text to be presented.

According to some implementations of the present disclosure, in a process of obtaining the text resource mapping of the application, a target language environment for running the application may be determined, and then the text resource mapping corresponding to the target language environment is obtained. Specifically, in the English environment 620, a text resource mapping corresponding to the configuration information 310 may be obtained. Then, in response to detecting the user's long press on the control 120, it may be determined that the text “HOME” in the English environment corresponds to the keyword “key01”. In the Chinese environment 622, the text resource mapping may be obtained corresponding to the configuration information 610, and so on. Then, in response to detecting the user's long press on the control 120, it may be determined that a text “home” in the Chinese environment corresponds to the keyword “key01”.

With some implementations of the present disclosure, the text resource mapping may store a bidirectional mapping relationship between the text and the keyword of the text. In this way, the text resources in the application may be managed in a simpler and effective manner, helping the user to adjust the specific content of the text in the development and testing process.

### Example Processes

FIG. 7 illustrates a flowchart of a method 700 for managing text resources in an application according to some implementations of the present disclosure. At block 710, a text resource mapping of the application is obtained, the text resource mapping comprises a text of a control in the application, and a keyword of the text of the control. At block 720, in response to receiving an interaction request with the application, a target control in the application is determined based on the interaction request. At block 730, a target text corresponding to the target control is determined. At block 740, in response to determining that the target text matches the text, the keyword of the text is determined based on the text resource mapping.

According to some implementations of the present disclosure, determining the target text corresponding to the target control comprises: determining a text view corresponding to the target control in the application; and determining the target text in the text view.

According to some implementations of the present disclosure, obtaining the text resource mapping comprises: obtaining a class corresponding to a text resource in the application; extracting the keyword of the text and a resource identifier corresponding to the keyword from the class; and determining the text resource mapping based on a text of the text resource identified by the resource identifier and the keyword.

According to some implementations of the present disclosure, the class is obtained during running of the application.

According to some implementations of the present disclosure, obtaining the text resource mapping comprises: reading the text and the keyword of the text from the configuration information of the application; and determining the text resource mapping based on the text and the keyword.

According to some implementations of the present disclosure, the application is implemented in a multi-language environment, and the text is represented in a target language of the plurality of languages.

According to some implementations of the present disclosure, obtaining the text resource mapping of the application comprises: determining a target language environment for running the application; and obtaining the text resource mapping corresponding to the target language environment.

According to some implementations of the present disclosure, in response to receiving an edit request for the text, the text in the text resource mapping is updated.

### Example Apparatuses and Devices

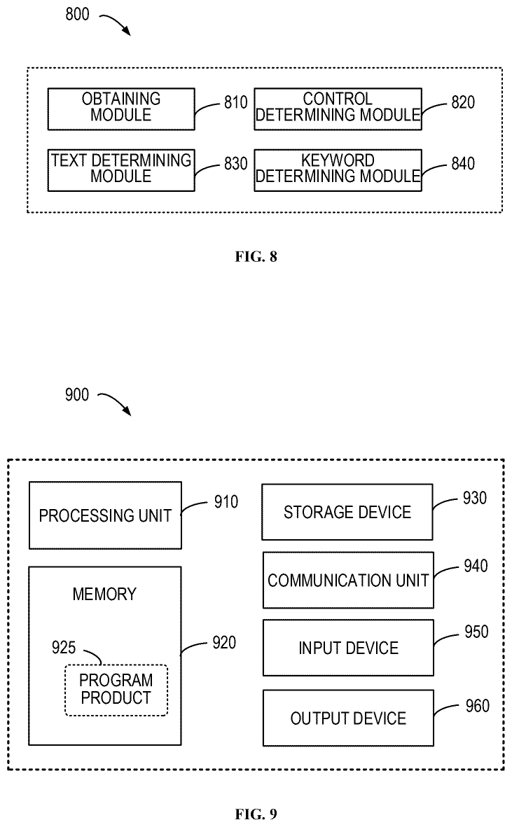

FIG. 8 illustrates a block diagram of an apparatus 800 for managing text resources in an application according to some implementations of the present disclosure. The apparatus 800 comprises: an obtaining module 810 configured to obtain a text resource mapping of the application, the text resource mapping comprising a text of a control in the application and a keyword of the text of the control; a control determining module 820 configured to determine, in response to receiving an interaction request with the application, a target control in the application based on the interaction request; a text determining module 830 configured to determine a target text corresponding to the target control; and a keyword determining module 840 configured to determine, in response to determining that the target text matches the text, the keyword of the text based on the text resource mapping.

According to some implementations of the present disclosure, the text determining module is further configured to: determine a text view corresponding to the target control in the application; and determine the target text in the text view.

According to some implementations of the present disclosure, the obtaining module is further configured to: obtain a class corresponding to a text resource in the application; extract the keyword of the text and a resource identifier corresponding to the keyword from the class; and determine the text resource mapping based on a text of a text resource identified by the resource identifier and the keyword.

According to some implementations of the present disclosure, the class is obtained during running of the application.

According to some implementations of the present disclosure, the obtaining module is further configured to: read the text and the keyword of the text from the configuration information of the application; and determine the text resource mapping based on the text and the keyword.

According to some implementations of the present disclosure, the application is implemented in a multi-language environment, and the text is represented in a target language of the plurality of languages.

According to some implementations of the present disclosure, the obtaining module is further configured to: determine a target language environment for running an application; and obtain the text resource mapping corresponding to the target language environment.

According to some implementations of the present disclosure, the apparatus further comprises an updating module configured to update the text in the text resource mapping in response to receiving an edit request for the text.

FIG. 9 illustrates a block diagram of a device 900 capable of implementing various implementations of the present disclosure. It should be understood that the computing device 900 shown in FIG. 9 is merely exemplary and should not constitute any limitation on a functionality and scope of the implementations described herein. The computing device 900 shown in FIG. 9 may be configured to implement the method described above.

As shown in FIG. 9, the computing device 900 is in a form of a general-purpose computing device. Components of the computing device 900 may comprise, but are not limited to, one or more processors or processing units 910, a memory 920, a storage device 930, one or more communication units 940, one or more input devices 950, and one or more output devices 960. The processing unit 910 may be an actual or virtual processor and capable of performing various processes according to a program stored in the memory 920. In a multiprocessor system, multiple processing units execute computer-executable instructions in parallel to improve parallel processing capability of the computing device 900.

Computing device 900 typically comprises a plurality of computer storage media. Such media may be any available media accessible by the computing device 900, comprising, but not limited to, volatile and non-volatile media, removable and non-removable media. The memory 920 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 930 may be a removable or non-removable medium and may comprise a machine-readable medium, such as a flash drive, magnetic disk, or any other medium, which may be capable of storing information and/or data (e.g., training data for training) and may be accessed within the computing device 900.

The computing device 900 may further comprise additional removable/non-removable, volatile/non-volatile storage media. Although not shown in FIG. 9, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 920 may comprise a computer program product 925 having one or more program modules configured to perform various methods or actions of various implementations of the present disclosure.

The communication unit 940 implements communications with other computing devices over a communications medium. Additionally, a functionality of the components of the computing device 900 may be implemented in a single computing cluster or multiple computing machines capable of communicating over a communication connection. Thus, the computing device 900 may operate in a networked environment using logical connections with one or more other servers, network personal computers (PCs), or another network node.

The input device 950 may be one or more input devices, such as a mouse, a keyboard, a trackball, or the like. The output device 960 may be one or more output devices, such as a display, a speaker, a printer, or the like. The computing device 900 may also communicate with one or more external devices (not shown) as needed, external devices such as storage devices, display devices, etc., communicate with one or more devices that enable a user to interact with the computing device 900, or communicate with any device (e.g., network card, modem, etc.) that enables the computing device 900 to communicate with one or more other computing devices. Such communication may be performed via an input/output (I/O) interface (not shown).

According to an implementation of the present disclosure, there is provided a computer-readable storage medium having computer-executable instructions stored thereon, wherein the computer-executable instructions are executed by a processor to implement the method described above. According to an implementation of the present disclosure, a computer program product is further provided, the computer program product being tangibly stored on a non-transitory computer-readable medium and comprising computer-executable instructions, and the computer-executable instructions being executed by a processor to implement the method described above. According to an implementation of the present disclosure, a computer program product comprising a computer program is provided, wherein the program, when executed by a processor, implement the foregoing method.

Aspects of the present disclosure are described herein with reference to flowcharts and/or block diagrams of methods, apparatuses, devices, and computer program products implemented according to the present disclosure. It should be understood that each block of a flowchart and/or block diagram, and combinations of blocks in the flowchart and/or block diagram, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement functions/acts specified in the flowchart and/or block diagram. These computer-readable program instructions may also be stored in a computer-readable storage medium that cause the computer, the programmable data processing apparatus, and/or other devices to operate in a particular manner, such that the computer-readable medium storing instructions comprises an article of manufacture comprising instructions to implement aspects of the functions/acts specified in the flowchart and/or block diagram (s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that comprises one or more executable instructions for implementing specified logical function. In some alternative implementations, functions noted in the blocks may also occur in a different order than noted in the drawings. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. Selection of terms used herein is intended to best explain the principles of the implementations, practical applications, or improvements to techniques in the marketplace, or to enable others of ordinary skill in the art to understand the various implementations disclosed herein.

1. A method for managing text resources in an application, comprising:
obtaining a text resource mapping of the application, the text resource mapping comprising a text of a control in the application and a keyword of the text of the control;
determining, in response to receiving an interaction request with the application, a target control in the application based on the interaction request;
determining a target text corresponding to the target control; and
determining, in response to determining that the target text matches the text, the keyword of the text based on the text resource mapping.

2. The method of claim 1, wherein determining the target text corresponding to the target control comprises:
determining a text view corresponding to the target control in the application; and
determining the target text in the text view.

3. The method of claim 1, wherein obtaining the text resource mapping comprises:
obtaining a class corresponding to a text resource in the application;
extracting the keyword of the text and a resource identifier corresponding to the keyword from the class; and
determining the text resource mapping based on a text of a text resource identified by the resource identifier and the keyword.

4. The method of claim 3, wherein the class is obtained during running of the application.

5. The method of claim 1, wherein obtaining the text resource mapping comprises:
reading the text and the keyword of the text from configuration information of the application; and
determining the text resource mapping based on the text and the keyword.

6. The method of claim 1, wherein the application is implemented in a multi-language environment and the text is represented in a target language of a plurality of languages.

7. The method of claim 6, wherein obtaining the text resource mapping of the application comprises:
determining a target language environment for running the application; and
obtaining the text resource mapping corresponding to the target language environment.

8. The method of claim 1, further comprising: updating the text in the text resource mapping in response to receiving an edit request for the text.

9. An electronic device, comprising:
at least one processor; and
at least one memory coupled to the at least one processor and storing instructions for execution by the at least one processor, the instructions, when executed by the at least one processor, causing the electronic device to perform acts comprising:
obtaining a text resource mapping of the application, the text resource mapping comprising a text of a control in the application and a keyword of the text of the control;
determining, in response to receiving an interaction request with the application, a target control in the application based on the interaction request;
determining a target text corresponding to the target control; and
determining, in response to determining that the target text matches the text, the keyword of the text based on the text resource mapping.

10. The electronic device of claim 9, wherein determining the target text corresponding to the target control comprises:
determining a text view corresponding to the target control in the application; and
determining the target text in the text view.

11. The electronic device of claim 9, wherein obtaining the text resource mapping comprises:
obtaining a class corresponding to a text resource in the application;
extracting the keyword of the text and a resource identifier corresponding to the keyword from the class; and
determining the text resource mapping based on a text of a text resource identified by the resource identifier and the keyword.

12. The electronic device of claim 11, wherein the class is obtained during running of the application.

13. The electronic device of claim 9, wherein obtaining the text resource mapping comprises:
reading the text and the keyword of the text from configuration information of the application; and
determining the text resource mapping based on the text and the keyword.

14. The electronic device of claim 9, wherein the application is implemented in a multi-language environment and the text is represented in a target language of a plurality of languages.

15. The electronic device of claim 14, wherein obtaining the text resource mapping of the application comprises:
determining a target language environment for running the application; and
obtaining the text resource mapping corresponding to the target language environment.

16. The electronic device of claim 9, wherein the acts further comprise: updating the text in the text resource mapping in response to receiving an edit request for the text.

17. A non-transitory computer-readable storage medium having stored thereon computer instructions that, when executed by a processor, cause the processor to implement acts comprising:
obtaining a text resource mapping of the application, the text resource mapping comprising a text of a control in the application and a keyword of the text of the control;
determining, in response to receiving an interaction request with the application, a target control in the application based on the interaction request;
determining a target text corresponding to the target control; and
determining, in response to determining that the target text matches the text, the keyword of the text based on the text resource mapping.

18. The non-transitory computer-readable storage medium of claim 17, wherein determining the target text corresponding to the target control comprises:
determining a text view corresponding to the target control in the application; and
determining the target text in the text view.

19. The non-transitory computer-readable storage medium of claim 17, wherein obtaining the text resource mapping comprises:
obtaining a class corresponding to a text resource in the application;
extracting the keyword of the text and a resource identifier corresponding to the keyword from the class; and
determining the text resource mapping based on a text of a text resource identified by the resource identifier and the keyword.

20. The non-transitory computer-readable storage medium of claim 19, wherein the class is obtained during running of the application.
